(19) United States
(12) Patent Application Publication
(10) Pub. No.: US 2023/0205943 A1
(43) Pub. Date: Jun. 29, 2023

(54) REAL-TIME SIMULATION METHOD OF SEWAGE PIPE NETWORK BASED ON WATER SUPPLY IOT DATA ASSIMILATION

(71) Applicant: Zhejiang University, Hangzhou (CN)

(72) Inventors: Feifei Zheng, Hangzhou (CN); Qingzhou Zhang, Hangzhou (CN)

(21) Appl. No.: 18/171,441

(22) Filed: Feb. 20, 2023

Related U.S. Application Data
(63) Continuation of application No. PCT/CN20/20149, filed on Oct. 10, 2020.

(30) Foreign Application Priority Data
Aug. 18, 2020 (CN) 202010832786.9

(51) Int. Cl. G06F 30/18

(52) U.S. Cl. CPC G06F 30/18; G06F 2113/08

(57) ABSTRACT

A sewage pipe network real-time simulation method based on water supply Internet of Things data drive. The method involves an offline module and a real-time online module, wherein the offline module integrates a sewage pipe network model and a water supply pipe network hydraulic model, corrects historical water consumption of each node of the water supply pipe network hydraulic model, establishes a correction single-objective optimization model of the sewage pipe network model, and determines a transfer coefficient between the water consumption of each node and an inflow of an inspection well; and the real-time online module realizes the real-time simulation of hydraulic parameters of the sewage pipe network model. The method fills a vacancy in the field of sewage pipe network real-time simulation, and important technical support is provided for the management of sewage pipe network systems, and the method has good value in promotion and practical engineering application.

### CROSS REFERENCE TO RELATED APPLICATIONS

The present application is a Continuation application of PCT Application No. PCT/CN2020/120149 filed on Oct. 10, 2020, which claims the benefit of Chinese Patent Application No. 202010832786.9 filed on Aug. 18, 2020. All the above are hereby incorporated by reference in their entirety.

### FIELD OF THE INVENTION

The present invention generally relates to municipal engineering urban water supply and drainage pipe networks, and particularly relates to a real-time simulation technology of sewage pipe network based on water supply IoT data assimilation.

### BACKGROUND

The safe operation of urban sewage pipe network directly affects the urban water environment, water safety and peoples health. In recent years, with the rapid growth of the urban population, the sewage pipe network is constantly expanding and the topology has become more complicated; moreover, the system has become more aging, which has brought great difficulties to the operation and management of the sewage pipe network. The problems that the urban sewage pipe network is prone to produce mainly include pipe network deposition, illegal discharge of sewage, pipe leakage, and sewage pipe misconnection and sewage overflow, etc. All these problems have posed a serious threat to the urban water environment, which is the root cause of urban black and odorous water bodies.

In the prior art, these problems are directly solved by placement of built-in sensors in the sewage pipe network, to monitor the water depth and the follow information in the pipes in a real time and achieve the forecast, early warning and positioning of abnormal events. However, due to the extremely high costs for the purchase and maintenance of the sewage sensors, usually there is very limited pipe networks placed in the pipe network, and the alarm of abnormal events (such as overflow or leakage) is given in small area around the monitoring point only. In addition, the abnormal observation results of the monitoring points may result from a sudden increase in the users water consumption; therefore, the monitoring point data analysis method without considering the change in the water consumption easily leads to a high false alarm rate. More importantly, the operating status (water depth and flow) of the entire sewage pipe network for a period of time in the future cannot be predicted only through sensor observations, thus, effective prevention and control cannot be achieved. An important method to solve these key problems is to establish a hydraulic model of the sewage pipe network to simulate and predict the water depth and flow parameters at any position of the entire pipe network in real time. In addition, the data of limited monitoring points are combined to diagnose whether there are pipe blockage, leakage, discharge and connection in violation of regulations in real time, and more importantly, the overflow of all inspection wells of the sewage pipe network can be predicted in real time.

The key to realizing the real-time hydraulic simulation of the sewage pipe network is to obtain the real-time sewage inflow of each inspection well. However, it is not realistic to obtain the flow data with high temporal and spatial resolution in the actual engineering, which is also the bottleneck of real-time simulation of sewage pipe network. Researchers have proposed many optimization methods to invert the real-time sewage inflow of the inspection well through the observation data of limited monitoring points. However, a major defect of these methods is the multiplicity of solution for sewage flow optimization, that is, the different combinations of the inflow values of each inspection well can still guarantee the consistency between the simulated value and the observation value at the monitoring point. Therefore, it is difficult to determine whether the optimal solution can represent the true hydraulic operating status of the sewage pipe network, thus, the effective monitoring of the sewage pipe network cannot be realized.

### SUMMARY

In order to solve the foregoing bottleneck problems in the prior art, the present invention provides a real-time simulation method of sewage pipe network driven by water supply IoT data for the first time. By integrating water supply pipe network models in the same area, the water consumption of water supply pipe network nodes at each time point is allocated to the nearest inspection well of the sewage pipe network, then the optimal transfer factor between the node water consumption and the inspection well inflow is determined by an optimization method to effectively solve the problem of multiplicity of solution, finally, based on real-time water supply data and the determined optimal transfer factor, the real-time simulation of the water depth and flow parameters of the entire sewage pipe network is realized. The innovation of the present invention is to achieve in-depth integration and data assimilation of the water supply system Internet of Things (IoT) and the sewage pipe network, which have become increasingly mature in recent years. The water supply IoT includes many pressure gauges, flow meters and intelligent water meters, which can provide water consumption information for users in real time, thereby driving the real-time simulation of the sewage pipe network. In the present invention, the real-time hydraulic model of the sewage pipe network is used, which provides a key technical support for effectively solving the problems of pipe blockage, illegal discharge of sewage, pipe leakage, and sewage pipe misconnection and sewage overflow.

In order to solve the foregoing technical problems, the present invention adopts the following technical solutions:

A real-time simulation method of sewage pipe network driven by water supply IoT data, comprising the following steps:

Process 1: Offline module, including three stages S1, S2 and S3, the execution frequency and number of times of offline module are determined according to actual needs,

S1: Integrating a hydraulic model of a sewage pipe network and a water supply pipe network according to the steps S11 to S12,

S11: Establishing a hydraulic model of a sewage pipe network and a water supply pipe network based on parameter information of model components such as water supply pipes, reservoirs, pumping stations, sewage pipes, inspection wells, etc. provided by a geographic information system GIS (FIG. 1),

S12: Establishing a mapping relationship between nodes of the water supply network model and the inspection wells of the sewage pipe network model based on the spatial analysis functions of GIS, so that the drainage of each water supply node in the model enters a spatially nearest sewage inspection well (FIG. 2);

S2: Correcting the historical water consumption of each node in the hydraulic model of the water supply pipe network according to steps S21 to S27,

S21: Setting the required related parameters: observed values H^{o} and Q^{o} in all pressure monitoring points and flow monitoring points in the water supply pipe network at a historical time point t; an error threshold; a maximum number S of iterations and an adjustment range p of node water consumption,

S22: Initializing the water consumption of each node at a historical time point t: For a water supply pipe network with a given number Nₓ of nodes, intelligent water meters are installed at N_{y} nodes (y<x), firstly the water consumption of N_{y} separate metering is allocated to the corresponding nodes, and the remaining water is distributed to the remaining Nₓ−N_{y} nodes in proportion to the length of the pipe connecting each node with the adjacent nodes according to the following formula:

$${q}_{r}^{initial} = \frac{{l}_{r}}{{L}_{T} - {L}_{M}} ( {Q}_{T} - {Q}_{M} ) \qquad 1 - 1$$

in the formula, qᵣ^{initial} (r=1, 2, . . . , Nₓ−N_{y}) is the node water consumption of the node r allocated in proportion to the length of the pipe at a historical time point t after initialization, lᵣ is the total length of the pipe connected to the node r, L_{T} is the total length of the pipe of the water supply pipe network, L_{M} is the total length of the pipe connected to the intelligent water meter node; Q_{T} is the total water supply volume of the water supply pipe network; Q_{M} is the total water volume of the intelligent water meter at a historical time point t,
There are a total of Nₓ nodes in the pipe network, intelligent water meters are installed in a part of nodes (N_{y}) and the water consumption at a historical time point t is directly available from the intelligent water meters, while no intelligent water meters are installed in another part of nodes (Nₓ−N_{y}) and the water consumption at a historical time point t is unknown, and the water consumption of these nodes (Nₓ−N_{y}) at the historical time point t is calculated according to the formula 1-1, the total initial water consumption of all nodes in the water supply pipe network at the historical time point t is equal to the sum of the initial water consumptions of all nodes (a total of Nₓ nodes) at the historical time point t,

S23: Calculating the residual between the observed value and the simulated value at the pressure and flow monitoring points at the historical time point t: running the hydraulic simulation of the water supply pipe network and calculating (s=1, 2, . . . , S) at the s-th iteration, wherein, the residual between the observed value and the simulated value at the pressure monitoring points is:

ΔH^{s}=H^{o}−H(q)=[H₁^{o}−H₁(q)^{s},H₂^{o}−H₂(q)^{s}, . . . ,H_{NH}^{o}−H_{NH}(q)^{s}]^{T} 1-2

the residual between the observed value and the simulated value at the flow monitoring points is:

ΔQₛ=Q^{o}−Q(q)=[Q₁^{o}−Q₁(q)^{s},Q₂^{o}−Q₂(q)^{s}, . . . ,Q_{NQ}^{o}−Q_{NQ}(q)^{s}]^{T} 1-3

In the formula, NH and NQ are the numbers of pressure and flow monitoring points respectively, Hᵤ^{o} and Hᵤ(q)^{s} are the observed value and the simulated value (u=1, 2, . . . , NH) at the s-th iteration at the pressure monitoring point u, Qᵥ^{o} and Qᵥ(q)^{s} are observed value and the simulated value (v=1, 2, . . . , NH) at the s-th iteration at the pressure monitoring point v, T represents the transposition of vector, and q=[q₁^{s}, q₂^{s}, . . . q_{Nx}^{s}] is the vector of the node water consumption at the s-th iteration at the historical time point t;

S24: Calculating the adjusted value of the node water consumption at the historical time point t according to the following formula:

$$Δ {q}^{s} = {{( {[ \begin{matrix}{J}_{H} \\ {J}_{Q}\end{matrix} ]}^{T} W [ \begin{matrix}{J}_{H} \\ {J}_{Q}\end{matrix} ] )}^{- 1} [ \begin{matrix}{J}_{H} \\ {J}_{Q}\end{matrix} ]}^{T} W [ \begin{matrix}Δ {H}^{s} \\ Δ {Q}^{s}\end{matrix} ] \qquad 1 - 4$$

In the formula, J_{H} and J_{Q} are the Jacobian matrices of the water supply pipe network at the s-th iteration; wherein,

$${J}_{h} = \frac{\partial H ( q )}{\partial q} {\vert}_{q = {q}^{s}} , {J}_{Q} = \frac{\partial Q ( q )}{\partial q} {\vert}_{q = {q}^{s}} ;$$

wₕ^{u}=1/(Hᵤ^{o})² and w_{q}^{v}=1/(Qᵥ^{o})² represent the weight coefficients of pressure monitoring point u and the flow monitoring point v respectively; w=diag([wₕ¹, wₕ², . . . , wₕ^{NH}, w_{q}¹, w_{q}², . . . , w_{q}^{NQ}]) is the vector of weight coefficients,

S25: updating the water consumption of each node according to the following formula:

$$\begin{matrix}{q}^{s + 1} = {q}^{s} + Δ {q}^{s} & 1 - 5 \\ {q}_{r}^{s + 1} = \{ \begin{matrix}{q}_{r}^{min} , & if {q}_{r}^{s + 1} < {q}_{r}^{min} \\ {q}_{r}^{max} , & if {q}_{r}^{s + 1} > {q}_{r}^{max} \\ {q}_{r}^{s + 1} , & others\end{matrix} & 1 - 6\end{matrix}$$

In the formula, q^{s+1} is the water consumption of each node at the s+1-th iteration at the historical time point t; qᵣ^{min}=(1−p)×qᵣ^{initial} and qᵣ^{max}=(1+p)×qᵣ^{initial} are the minimum and maximum water consumption of a node r at the historical time point t respectively, generally p=10%˜20%,

S26: Repeating the process S23 to S24 until ∥Δq^{s}∥<ε or s>S, generally ε=0.01, S=100,

S27: Repeating the process S21 to S26 to obtain the data of node water consumption of the water supply pipe network whose historical time cycle is T (usually 2 weeks) and time accuracy is Δt (the time difference between two successive time points t, usually half an hour) for calculation in S3;

S3: Establishing a sewage pipe network model to correct a single-objective optimization model according to the steps S31 to S32, and determining the transfer factor between the water consumption of each node and the inflow of the inspection well,

S31: establishing a single objective function according to the following formula:

$$Minimization function : F ( K ) = {\sum }_{t = {T}_{w}}^{T} ( {\sum }_{i = 1}^{M} {[ g ( {h}_{i}^{o} ( t ) ) - g ( {h}_{i}^{s} ( t ) ) ]}^{2} + {\sum }_{j = 1}^{N} {[ g ( {f}_{j}^{o} ( t ) ) - g ( {f}_{j}^{s} ( t ) ) ]}^{2} ) \qquad 1 - 7$$

$$[ {h}_{i}^{s} , {f}_{i}^{s} ] = [ {h}_{i}^{s} ( {t}_{1} ) , {h}_{i}^{s} ( {t}_{2} ) , … , {h}_{i}^{s} ( T ) ; {f}_{j}^{s} ( {t}_{1} ) , {f}_{j}^{s} ( {t}_{2} ) , … , {f}_{j}^{s} ( T ) ] = {F}_{s} ( D ( T ) ) \qquad 1 - 8$$

$$D ( T ) = [ \begin{matrix}{d}_{1} ( {t}_{1} ) , {d}_{2} ( {t}_{2} ) , … {d}_{n} ( {t}_{1} ) \\ {d}_{1} ( {t}_{1} ) , {d}_{2} ( {t}_{2} ) , … {d}_{n} ( {t}_{2} ) \\ …………………………… \\ {d}_{1} ( T ) , {d}_{2} ( T ) , … {d}_{n} ( T )\end{matrix} ] \qquad 1 - 9$$

$${d}_{l} ( t ) = {k}_{l} \times {q}_{l} ( t ) \qquad 1 - 10$$

$${k}_{l}^{min} \leq {k}_{l} \leq {k}_{l}^{max} , l = 1 , 2 , … , n \qquad 1 - 11$$

In the formula, K=[k₁, k₂, . . . kₙ]^{T}, k₁ is the water consumption transfer factor of the inspection well l in the sewage pipe network model, T is the total simulation time of the model correction of the sewage pipe network, T, is the simulation hot start time of the sewage pipe network, M and N are the quantities of liquid level meters and flow meters installed in the sewage pipe network respectively, and are obtained in the sewage pipe network data acquisition system; hᵢ^{o}(t) and hᵢ^{s}(t) are the liquid level observation value and simulation value at the liquid level monitoring point i at the historical time point t respectively, fₕ^{o}(t) and fⱼ^{s}(t) are the flow observation value and simulation value at the flow monitoring point j at the historical time point t respectively, hᵢ^{s}=[hᵢ^{s}(t₁), hᵢ^{s}(t₂), . . . , hᵢ^{s}(T)] and fᵢ^{s}=[fⱼ^{s}(t₁), fⱼ^{s}(t₂), . . . , fⱼ^{s}(T)] are respectively the vectors of simulation values of the liquid level monitoring point i and the flow monitoring point j at all time points in the entire historical cycle T, Fₛ(D(T)) is the combination vector of hᵢ^{s} and fᵢ^{s}, D(T) is a T×n matrix, representing the inflow of all inspection wells n at all time points in the entire cycle T, dₗ(t) is the inflow of the inspection well l at the historical time point t, qₗ(t) is the water consumption correction value of the water supply pipe network node corresponding to the inspection well l at the historical time point t; kₗ^{min} and kₗ^{max} are the minimum and maximum values of kₗ respectively; g( ) is a linear conversion function used to convert the liquid level and flow into the same interval, i.e. the range of 0 to 1, which is defined as:

$$g ( x ) = \frac{x - {x}_{min}}{{x}_{max} - {x}_{min}} \qquad 1 - 12$$

In the formula, x represents the observed value or simulated value of the monitoring point; xₘᵢₙ and xₘₐₓ are the upper limit and lower limit, which are generally obtained based on historical data statistics of a period of time (for example, 30 days) at the monitoring point,

S32: Solving the single-objective optimization model: using the genetic algorithm in the prior art to solve the optimization model and obtain the water consumption transfer factor kₗ (l=1, . . . , n) of each inspection well i;

Process 2: Real-time online module, including S4 stage, S4 stage is executed once every time point,

S4: Realizing the real-time simulation of hydraulic parameters of the sewage pipe network model according to the steps S41 to S43,

S41: Obtaining the pressure, flow and water consumption data at the current time point t from the pressure gauges, flow meters and intelligent water meters of the water supply pipe network, and correcting the node water consumption of the hydraulic model of the water supply pipe network at the current time point t according to the procedure S2,

S42: Calculating the inflow dₗ(t) of the current time point of each inspection well in the sewage pipe network according to formula 1-10 based on the water consumption of each node of the water supply system at the current time point t obtained in S41 and the water consumption transfer factor of each inspection well obtained in S3,

S43: Running the hydraulic model of the sewage pipe network to simulate the liquid level and the flow hydraulic parameters of the entire sewage pipe network with a time accuracy of Δt (usually half an hour) in real time.

Compared to the prior art, the present invention has the following advantages:

Firstly, the present invention proposes a data assimilation method between the water supply system and the sewage pipe network for the first time. By establishing the mapping relationship between the water consumption of the nodes of water supply pipe network and the inspection well inflow of the sewage pipe network, it effectively solves the problem of serious lack of inflow data of the sewage pipe network.

Secondly, the present invention proposes a calculation method for real-time correction of the water consumption of the nodes of water supply pipe network and single-objective optimization for the transfer factor of the inspection wells of the sewage pipe network. It has innovatively realized the real-time simulation method of the sewage pipe network driven by water supply data and completely solved the multiple solution problems that are common in the existing simulation technology of the sewage pipe network, realized the real-time and accurate simulation of the hydraulic parameters of liquid level and flow of the entire sewage pipe network.

Thirdly, the present invention fills the gap in the real-time simulation field of sewage pipe network. It is an important supplement to the research field of urban drainage pipe network management, provides important technical support for the management of sewage pipe network system, and has a good value for promotion and practical engineering applications.

### BRIEF DESCRIPTION OF THE DRAWINGS

FIG. 1 is a functional schematic diagram of a water supply pipe network and a sewage pipe network of the present invention.

FIG. 2 is an integrated schematic diagram of a water supply pipe network and a sewage pipe network of the present invention.

FIG. 3 is a road map for the specific implementation of the present invention.

FIG. 4 is a layout diagram of the BKN sewage pipe network and the water supply pipe network system and monitoring points in the embodiment.

FIG. 5 is a layout diagram of the XZN sewage pipe network system and monitoring points in the embodiment.

FIG. 6 is a layout diagram of the XZN water supply pipe network system and monitoring points in the embodiment.

FIG. 7 is a distribution diagram of the errors between the simulated values and monitored values of the Benk and XZN water supply pipe network monitoring points (a total of 816 time steps in the first 17 days).

FIG. 8 shows the comparison between the node water consumption corrected by the water supply pipe network and the known water consumption connected with the intelligent water meter in the embodiment: (a) example BKN (b) example XZN.

FIG. 9 is a transfer factor distribution diagram between the node water consumption and the inflow of the inspection well in the embodiment.

FIG. 10 shows the comparison between the simulated value and the observed value of the flow monitoring points on the first 17 days (correction stage) in the embodiment.

FIG. 11 shows the comparison between the simulated values and the observed values of the flow monitoring point (a) C1 and liquid level monitoring points (b) M1, (c) M2, (d) M3 in the model verification phase (the last 14 days) in the example BKN.

FIG. 12 shows the comparison between the simulated values and the observed values of the flow monitoring point (a) C1, (b) C2, and liquid level monitoring points (c) M1 and (d) M5 in the model verification phase (the last 14 days) in the example XZN.

FIG. 13 shows the comparison of the simulated value and the observed value of the liquid level monitoring point M5 and the simulated value of water depth of 10 nearby inspection wells in the example XZN.

### DETAILED DESCRIPTION

The present invention will be described in detail in conjunction with the drawings and embodiments, so that those skilled in the art can better understand the technical solutions of the present invention. It should be noted that the examples in the embodiments are listed to allow those skilled in the art to better understand and implement the technical solutions of the present invention, and should not be regarded as a limitation or early disclosure of the present invention.

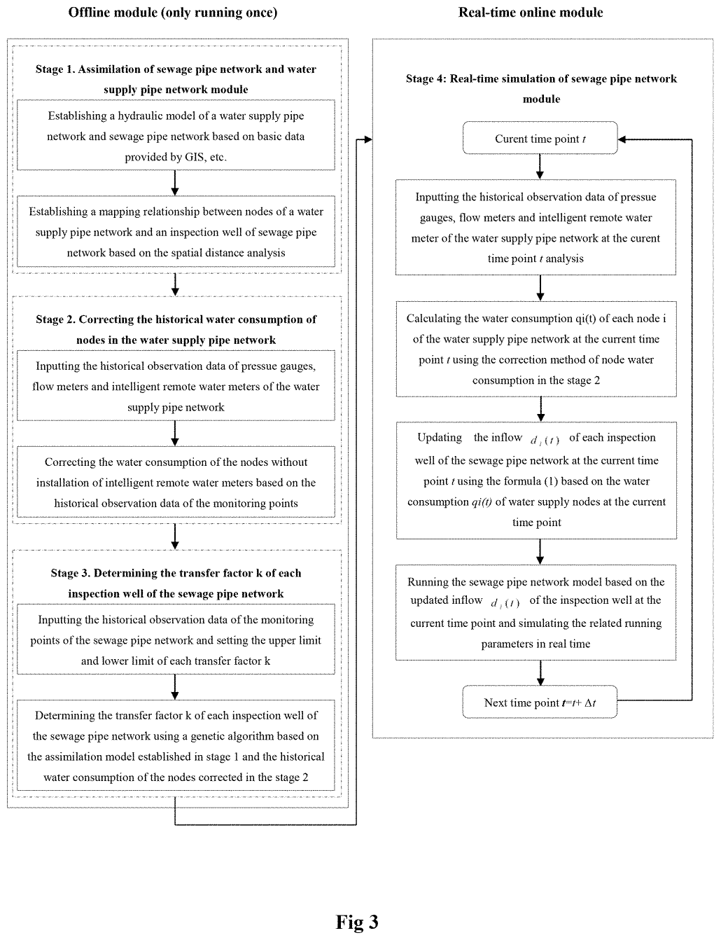

Referring to FIG. 3, a real-time simulation method of sewage pipe network driven by water supply IoT data, comprising the following steps:

Process 1: Offline module, including three stages S1, S2 and S3, the execution frequency and number of times of offline module are determined according to actual needs,

S1: Integrating a hydraulic model of a sewage pipe network and a water supply pipe network according to the steps S11 to S12,

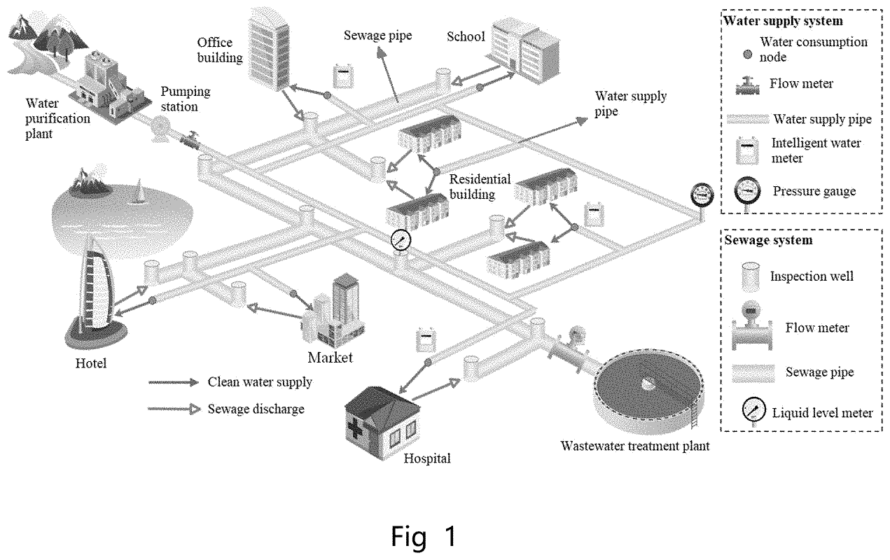

S11: Establishing a hydraulic model of a sewage pipe network and a water supply pipe network based on parameter information of model components such as water supply pipes, reservoirs, pumping stations, sewage pipes, inspection wells, etc. provided by a geographic information system GIS (FIG. 1),

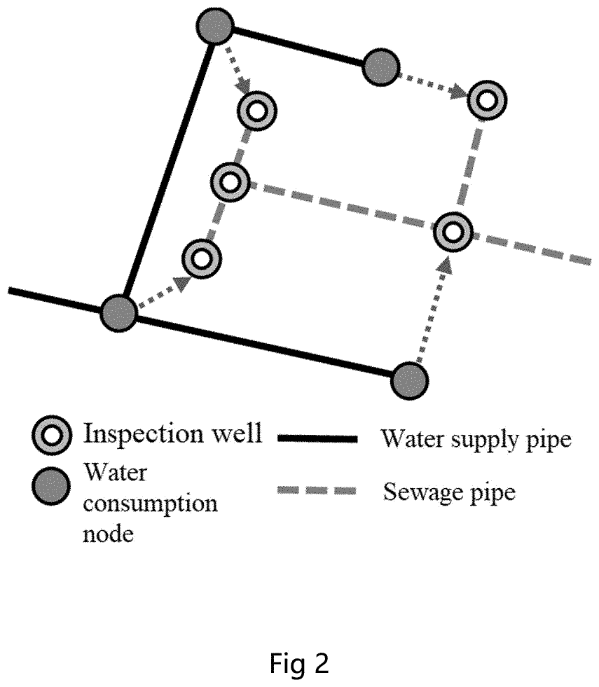

S12: Establishing a mapping relationship between nodes of the water supply network model and the inspection wells of the sewage pipe network model based on the spatial analysis functions of GIS, so that the drainage of each water supply node in the model enters a spatially nearest sewage inspection well (FIG. 2);

S2: Correcting the historical water consumption of each node in the hydraulic model of the water supply pipe network according to steps S21 to S27,

S21: Setting the required related parameters: observed values H^{o} and Q^{o} in all pressure monitoring points and flow monitoring points in the water supply pipe network at a historical time point t; an error threshold; a maximum number S of iterations and an adjustment range p of node water consumption,

S22: Initializing the water consumption of each node at a historical time point t: For a water supply pipe network with a given number Nₓ of nodes, intelligent water meters are installed at N_{y} nodes (y<x), firstly the water consumption of N_{y} separate metering is allocated to the corresponding nodes, and the remaining water is distributed to the remaining Nₓ−N_{y} nodes in proportion to the length of the pipe connecting each node with the adjacent nodes according to the following formula:

$${g}_{r}^{initial} = \frac{{l}_{r}}{{L}_{T} - {L}_{M}} ( {Q}_{T} - {Q}_{M} ) \qquad 1 - 1$$

in the formula, qᵣ^{initial} (r=1, 2, . . . , Nₓ−N_{y}) is the node water consumption of the node r allocated in proportion to the length of the pipe at a historical time point t after initialization, lᵣ is the total length of the pipe connected to the node r, L_{T} is the total length of the pipe of the water supply pipe network, L_{M} is the total length of the pipe connected to the intelligent water meter node; Q_{T} is the total water supply volume of the water supply pipe network; Q_{M} is the total water volume of the intelligent water meter at a historical time point t,
There are a total of Nₓ nodes in the pipe network, intelligent water meters are installed in a part of nodes (N_{y}) and the water consumption at a historical time point t is directly available from the intelligent water meters, while no intelligent water meters are installed in another part of nodes (Nₓ−N_{y}) and the water consumption at a historical time point t is unknown, and the water consumption of these nodes (Nₓ−N_{y}) at the historical time point t is calculated according to the formula 1-1, the total initial water consumption of all nodes in the water supply pipe network at the historical time point t is equal to the sum of the initial water consumptions of all nodes (a total of Nₓ nodes) at the historical time point t,
S23: Calculating the residual between the observed value and the simulated value at the pressure and flow monitoring points at the historical time point t: running the hydraulic simulation of the water supply pipe network and calculating (s=1, 2, . . . , S) at the s-th iteration, wherein,
the residual between the observed value and the simulated value at the pressure monitoring points is:

ΔH^{s}=H^{o}−H(q)=[H₁^{o}−H₁(q)^{s},H₂^{o}−H₂(q)^{s}, . . . ,H_{NH}^{o}−H_{NH}(q)^{s}]^{T} 1-2

the residual between the observed value and the simulated value at the flow monitoring points is:

ΔQ^{s}=Q^{o}−Q(q)=[Q₁^{o}−Q₂(q)^{s},Q₂^{o}−Q₂(q)^{s}, . . . ,Q_{NQ}^{o}−Q_{NQ}(q)^{s}]^{T} 1-3

In the formula, NH and NQ are the numbers of pressure and flow monitoring points respectively, Hᵤ^{o} and Hᵤ(q)^{s} are the observed value and the simulated value (u=1, 2, . . . , NH) at the s-th iteration at the pressure monitoring point u, Qᵥ^{o} and Qᵥ(q)^{s} are observed value and the simulated value (v=1, 2, . . . , NH) at the s-th iteration at the pressure monitoring point v, T represents the transposition of vector, and q=[q₁^{s}, q₂^{s}, . . . q_{Nx}^{s}] is the vector of the node water consumption at the s-th iteration at the historical time point t;

S24: Calculating the adjusted value of the node water consumption at the historical time point t according to the following formula:

$$Δ {q}^{s} = {{( {[ \begin{matrix}{J}_{H} \\ {J}_{Q}\end{matrix} ]}^{T} W [ \begin{matrix}{J}_{H} \\ {J}_{Q}\end{matrix} ] )}^{- 1} [ \begin{matrix}{J}_{H} \\ {J}_{Q}\end{matrix} ]}^{T} W [ \begin{matrix}Δ {H}^{s} \\ Δ {Q}^{s}\end{matrix} ] \qquad 1 - 4$$

In the formula, J_{H} and J_{Q} are the Jacobian matrices of the water supply pipe network at the s-th iteration; wherein,

$${J}_{H} = \frac{\partial H ( q )}{\partial q} {\vert}_{q = {q}^{s}} , {J}_{Q} = \frac{\partial Q ( q )}{\partial q} {\vert}_{q = {q}^{s}} ;$$

wₕ^{u}=1/(Hᵤ^{o})² and w_{q}^{v}=1/(Qᵥ^{o})² represent the weight coefficients of pressure monitoring point u and the flow monitoring point v respectively; w=diag([wₕ¹, wₕ², . . . , wₕ^{NH}, w_{q}¹, w_{q}², . . . , w_{q}^{NQ}]) is the vector of weight coefficients,

S25: updating the water consumption of each node according to the following formula:

$$\begin{matrix}{q}^{s + 1} = {q}^{s} + Δ {q}^{s} & 1 - 5 \\ {q}_{r}^{s + 1} = \{ \begin{matrix}{q}_{r}^{min} , & if {q}_{r}^{s + 1} < {q}_{r}^{min} \\ {q}_{r}^{max} , & if {q}_{r}^{s + 1} > {q}_{r}^{max} \\ {q}_{r}^{s + 1} , & others\end{matrix} & 1 - 6\end{matrix}$$

In the formula, q^{s+1} is the water consumption of each node at the s+1-th iteration at the historical time point t; qᵣ^{min}=(1−p)×qᵣ^{initial} and qᵣ^{max}=(1+p)×qᵣ^{initial} are the minimum and maximum water consumption of a node r at the historical time point t respectively, generally p=10%˜20%,

S26: Repeating the process S23 to S24 until ∥Δq^{s}∥<ε or s>S, generally ε=0.01, S=100,

S27: Repeating the process S21 to S26 to obtain the data of node water consumption of the water supply pipe network whose historical time cycle is T (usually 2 weeks) and time accuracy is Δt (the time difference between two successive time points t, usually half an hour) for calculation in S3;

S3: Establishing a sewage pipe network model to correct a single-objective optimization model according to the steps S31 to S32, and determining the transfer factor between the water consumption of each node and the inflow of the inspection well,

S31: establishing a single objective function according to the following formula:

$$Minimization function : F ( K ) = {\sum }_{t = {T}_{w}}^{T} ( {\sum }_{i = 1}^{M} {[ g ( {h}_{i}^{o} ( t ) ) - g ( {h}_{i}^{s} ( t ) ) ]}^{2} + {\sum }_{j = 1}^{N} {[ g ( {f}_{j}^{o} ( t ) ) - g ( {f}_{j}^{s} ( t ) ) ]}^{2} ) \qquad 1 - 7$$

$$[ {h}_{i}^{s} , {f}_{i}^{s} ] = [ {h}_{i}^{s} ( {t}_{1} ) , {h}_{i}^{s} ( {t}_{2} ) , … , {h}_{i}^{s} ( T ) ; {f}_{j}^{s} ( {t}_{1} ) , {f}_{j}^{s} ( {t}_{2} ) , … , {f}_{j}^{s} ( T ) ] = {F}_{s} ( D ( T ) ) \qquad 1 - 8$$

$$D ( T ) = [ \begin{matrix}{d}_{1} ( {t}_{1} ) , {d}_{2} ( {t}_{2} ) , … {d}_{n} ( {t}_{1} ) \\ {d}_{1} ( {t}_{1} ) , {d}_{2} ( {t}_{2} ) , … {d}_{n} ( {t}_{2} ) \\ …………………………… \\ {d}_{1} ( T ) , {d}_{2} ( T ) , … {d}_{n} ( T )\end{matrix} ] \qquad 1 - 9$$

$${d}_{l} ( t ) = {k}_{l} \times {q}_{l} ( t ) \qquad 1 - 10$$

$${k}_{l}^{min} \leq {k}_{l} \leq {k}_{l}^{max} , l = 1 , 2 , … , n \qquad 1 - 11$$

In the formula, K=[k₁, k₂, . . . kₙ]^{T}, kₗ is the water consumption transfer factor of the inspection well l in the sewage pipe network model, T is the total simulation time of the model correction of the sewage pipe network, T_{w} is the simulation hot start time of the sewage pipe network, M and N are the quantities of liquid level meters and flow meters installed in the sewage pipe network respectively, and are obtained in the sewage pipe network data acquisition system; hᵢ^{o}(t) and hᵢ^{s}(t) are the liquid level observation value and simulation value at the liquid level monitoring point i at the historical time point t respectively, fⱼ^{o}(t) and fⱼ^{s}(t) are the flow observation value and simulation value at the flow monitoring point j at the historical time point t respectively, hᵢ^{s}=[hᵢ^{s}(t₁), hᵢ^{s}(t₂), . . . , hᵢ^{s}(T)] and fᵢ^{s}=[fⱼ^{s}(t₁), fⱼ^{s}(t₂), . . . , fⱼ^{s}T)] are respectively the vectors of simulation values of the liquid level monitoring point i and the flow monitoring point j at all time points in the entire historical cycle T, Fₛ(D(T)) is the combination vector of hᵢ^{s} and fᵢ^{s}, D(T) is a T×n matrix, representing the inflow of all inspection wells n at all time points in the entire cycle T, dₗ(t) is the inflow of the inspection well l at the historical time point t, qₗ(t) is the water consumption correction value of the water supply pipe network node corresponding to the inspection well l at the historical time point t; kₗ^{min} and kₗ^{max} are the minimum and maximum values of kₗ respectively; g( ) is a linear conversion function used to convert the liquid level and flow into the same interval, i.e. the range of 0 to 1, which is defined as:

$$g ( x ) = \frac{x - {x}_{min}}{{x}_{max} - {x}_{min}} \qquad 1 - 12$$

In the formula, x represents the observed value or simulated value of the monitoring point; xₘᵢₙ and xₘₐₓ are the upper limit and lower limit, which are generally obtained based on historical data statistics of a period of time (for example, 30 days) at the monitoring point,

S32: Solving the single-objective optimization model: using the genetic algorithm in the prior art to solve the optimization model and obtain the water consumption transfer factor kₗ (l=1, . . . , n) of each inspection well i;

Process 2: Real-time online module, including S4 stage, S4 stage is executed once every time point,

S4: Realizing the real-time simulation of hydraulic parameters of the sewage pipe network model according to the steps S41 to S43,

S41: Obtaining the pressure, flow and water consumption data at the current time point t from the pressure gauges, flow meters and intelligent water meters of the water supply pipe network, and correcting the node water consumption of the hydraulic model of the water supply pipe network at the current time point t according to the procedure S2,

S42: Calculating the inflow dₗ(t) of the current time point of each inspection well in the sewage pipe network according to formula 1-10 based on the water consumption of each node of the water supply system at the current time point t obtained in S41 and the water consumption transfer factor of each inspection well obtained in S3,

S43: Running the hydraulic model of the sewage pipe network to simulate the liquid level and the flow hydraulic parameters of the entire sewage pipe network with a time accuracy of Δt (usually half an hour) in real time. In the following description, the method will be combined with specific embodiments to demonstrate its specific technical effects. The specific steps of the method will not be repeated.

### Example

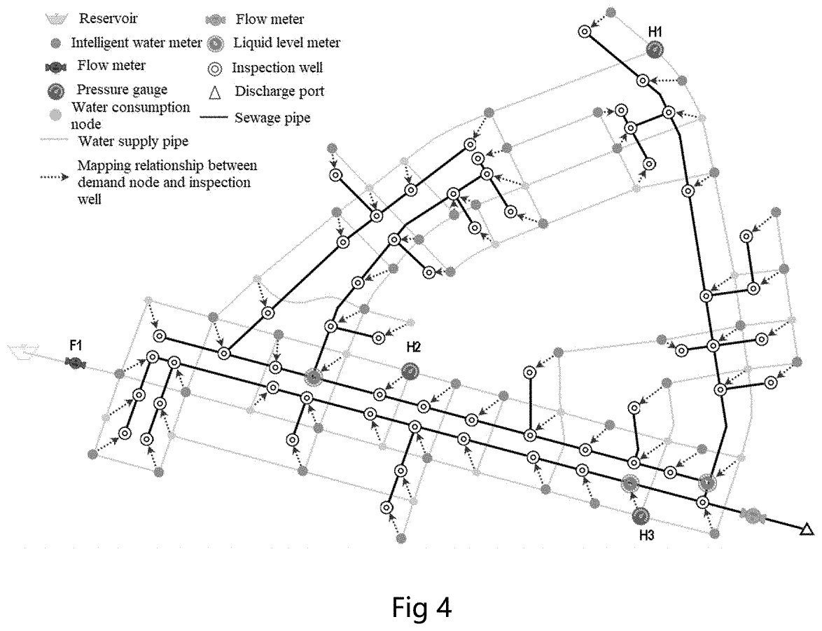

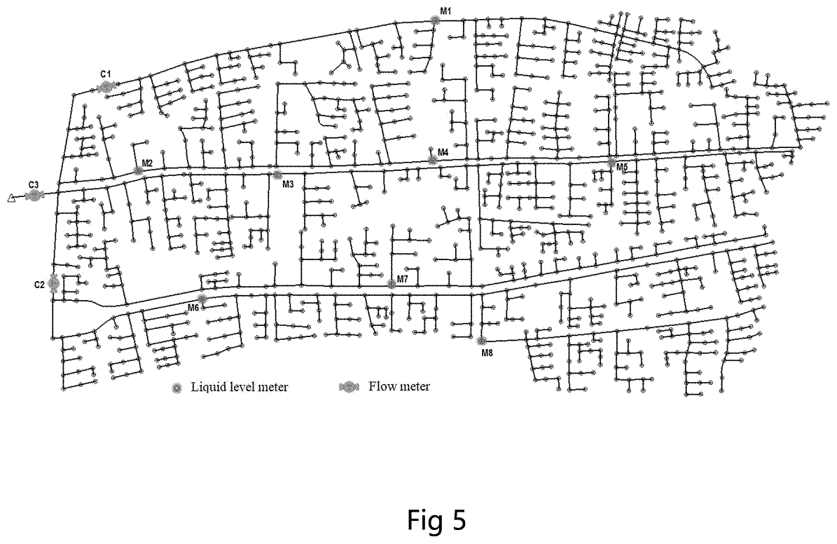

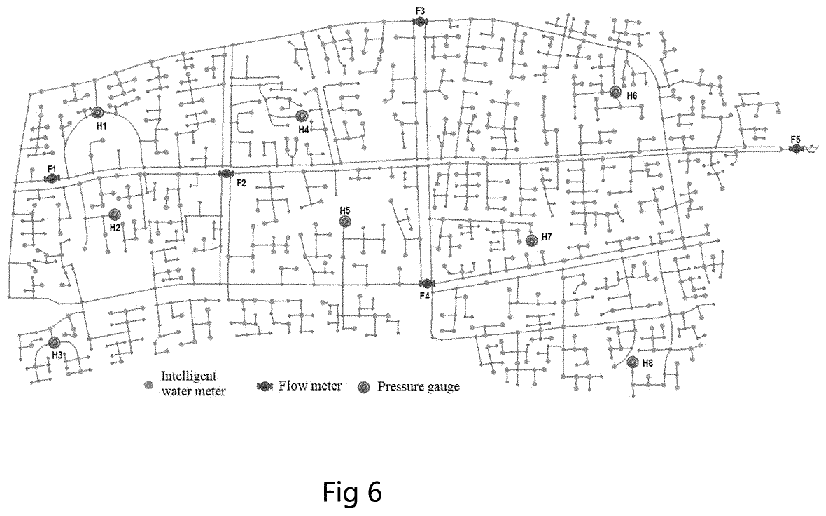

The foregoing method of the present invention was used to the sewage pipe networks of two cities (Benk and Xiuzhou), respectively. The sewage pipe network of the city of Benk (denoted as FSS-BKN) was composed of 1 sewage plant entrance, 64 inspection wells and 64 sewage pipes. There were 3 liquid level meters and 1 flow meter installed in the sewage pipe network (as shown in FIG. 4), and the sewage discharge was about 4100 tons/day; the corresponding water supply pipe network (denoted as WDS-BKN) was composed of 1 water plant, 65 water demand nodes and 93 water supply pipes. There were 3 pressure gauges, 1 flow meter and 40 intelligent water meters installed in the water supply pipe network, and the water supply amount was about 4800 tons/day; as shown in FIG. 4, the dotted arrow indicated the correspondence between the nodes of water supply pipe network and the inspection wells of the sewage pipe network. The sewage pipe network (denoted as FSS-XZN) in the city of Xiuzhou was composed of 1 sewage plant entrance, 1,214 inspection wells and 1,214 sewage pipes (as shown in FIG. 5). The total length was about 86 kilometers, and the sewage discharge amount was about 21,500 tons/day. There were 3 flow meters and 8 liquid level meters installed in the sewage pipe network; the corresponding water supply pipe network (denoted as WDS-XZN) was composed of 1 water plant, 1 pumping station, 1,119 nodes and 1,137 water supply pipes (as shown in FIG. 6), the water supply amount was about 23,150 tons/day, serving for about 107,500 people. There were 5 flow meters, 8 pressure gauges and 525 intelligent water meters installed in the water supply pipe network.

In each example, the historical data under the condition of no rainfall on 31 days of a month were recorded by a monitoring instrument, and the time step was about 30 minutes, so there were a total of 1488 (31×24×2) time steps of data. In the offline mode of process 1, the historical data of water supply pipe network and sewage pipe network monitoring points for the first 17 consecutive days (time step of 30 minutes) were chosen to determine the optimal transfer factor for each inspection well in the sewage pipe network model. In the optimization calculation of the transfer factor of the sewage pipe network inspection well, the hot start time T_{w} of the sewage pipe network model was 3 days, and the remaining 14 days of the 17 days were used to determine the transfer factor. Using the historical data of monitoring points of the water supply pipe network and the sewage pipe network for the last 14 consecutive days of 31 days, the real-time online simulation results of the sewage pipe network at each time point t were verified in the process 2.

During the verification of the node water consumption of the water supply pipe network, for each embodiment, the correction error threshold ε was 0.1; the maximum number of iterations S was 100 and the adjustment range of the node water consumption p was 20%. In the optimization calculation of the transfer factor of the inspection wells of the sewage pipe network, the minimum value of the transfer factor of the inspection well kₗ^{min} was 0.77. For the inspection well corresponding to the node water consumption provided by the intelligent water meter, the maximum value kₗ^{max} was 1.0, for the inspection well corresponding to the node water consumption obtained by hydraulic model calibration, considering the possible error for the verification, the maximum value kₗ^{max} was 1.3; the genetic algorithm population quantity in the conventional technology used was 500, the maximum number of iterations was 50,000, and the rest of parameters used the default values.

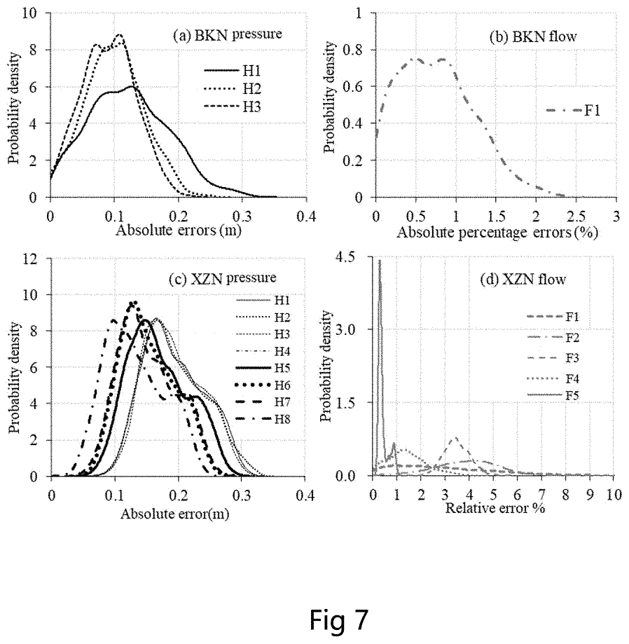

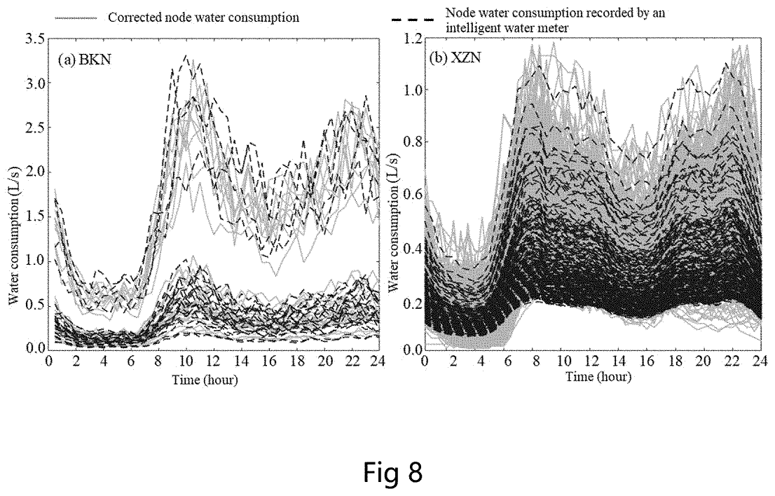

FIG. 7 showed a distribution diagram of the errors between the simulated values and monitored values of the Benk and XZN water supply pipe network monitoring points in the first 17 days (a total of 816 time steps). As shown from FIG. 7(a), the absolute error of more than 90% of all Benk pressure monitoring points was less than 0.32 meters, and the maximum value was 1.34%; in FIG. 7(b), at the Benk flow monitoring point of the water supply pipe network, the relative error of 93% flow was less than 1.5%, and its maximum value was 2.4%; as shown from FIG. 7(c), the absolute error at all pressure monitoring points of the water supply pipe network XZN was less than 0.5 meters; in FIG. 7(d), the relative error at most of the XZN flow monitoring points was less than 5%, and the maximum was 9.27%. FIG. 8 showed a comparison between the corrected value of node water consumption without an intelligent water meter and the true value of node water consumption with an intelligent water meter installed in two embodiments. As shown from the figure, the corrected node water consumption and the actual water consumption trend recorded in the intelligent water meter had the same trend, that is, the water consumption low peak period and the high peak period were the same, indicating that the corrected error of the node water consumption in the two embodiments meets the error requirement of the model application, and the corrected result of the node water consumption and the actual water consumption have the same trend. It is more scientific and reasonable, ensuring that the corrected hydraulic model can be accurately applied in practices.

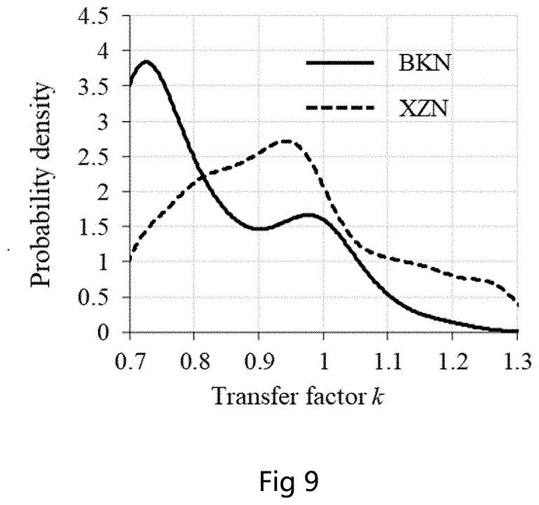

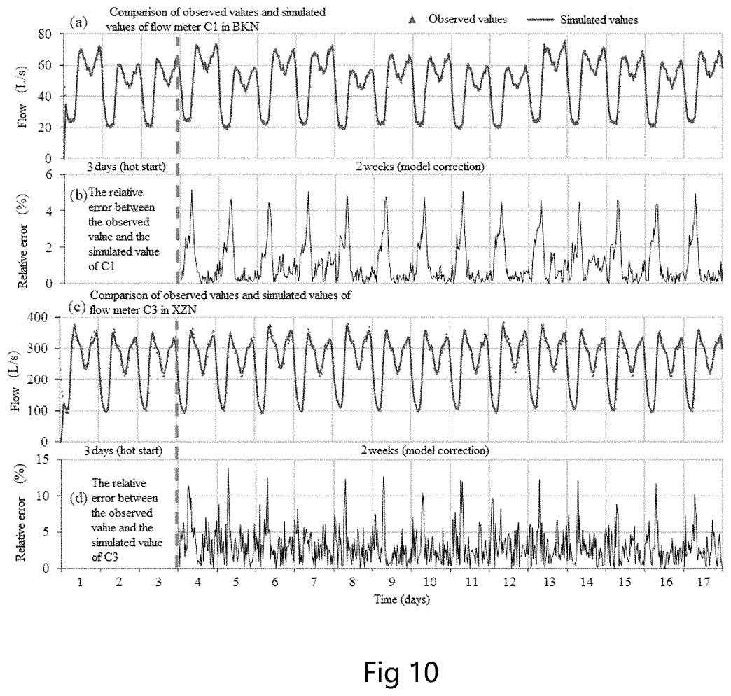

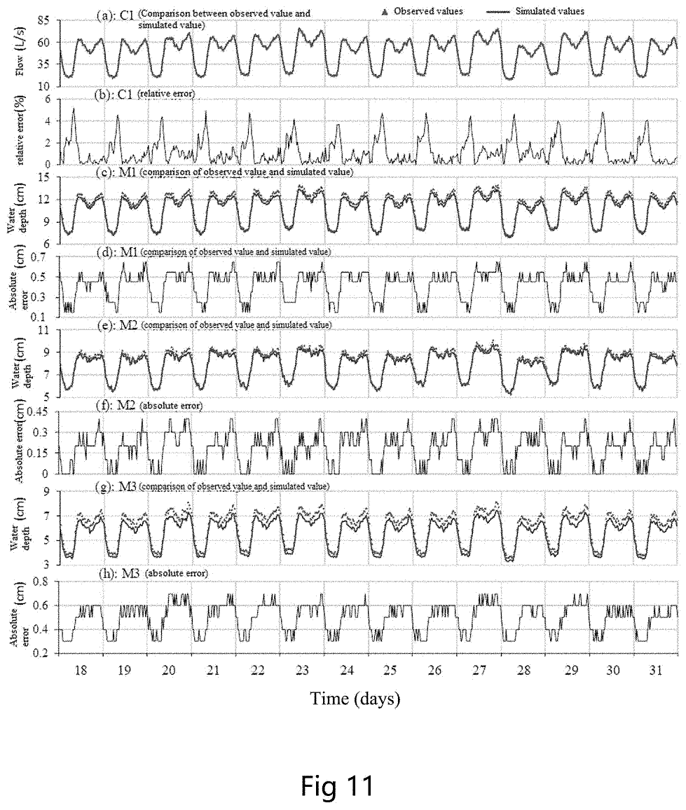

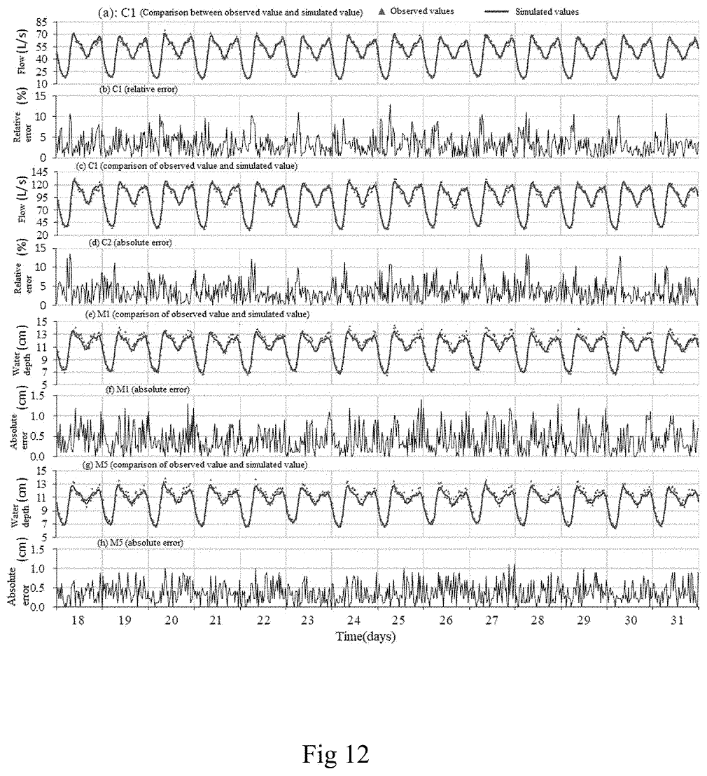

FIG. 9 was a transfer factor distribution diagram of the water consumption of the inspection wells of the sewage pipe network. As shown from the figure, most of the transfer factors of the sewage inspection wells were within the range of [0,1]. The average transfer factors of all inspection wells of Examples BKN and XZN were 0.83 and 0.92 respectively, which meant that the 83% and 92% of the total water consumption of the water supply pipe network enters the sewage pipe network through the inspection wells. FIG. 10(a) showed the comparison between the simulated values and the observed values of the sewage pipe network flow meter C1 on the first 17 days (correction stage) in the embodiment BKN. The relative error between the monitored value and the simulated value at all time points was less than 5%, and the maximum error and the average error were respectively 4.5% and 1.16% (FIG. 10b). FIG. 10(c) showed the comparison between the simulated values and the observed values of the sewage pipe network flow meter C3 on the first 17 days (correction stage) in the embodiment XZN, and the maximum relative error and the average relative error were 13.74% and 3.02%, respectively (FIG. 10d). FIG. 11 showed the comparison between the observed values and the simulated values of the sewage flow of flow meter C1 and the water depth observation values of liquid level meters M1, M2 and M3 of the sewage pipe network in the example BKN during the model verification stage (the last 14 days), of which, the maximum relative error of the flow was 4.91%, the maximum absolute error of the water depth was 0.7 cm. FIG. 12 showed the comparison between the simulated values and the observed values of the flow meters C1, C2 and the liquid level meters M1, M5 in the model verification stage (the last 14 days) in the example XZN. The maximum relative errors of flow meters C1 and C2 were 13.05% and 13.45%, respectively. The maximum absolute error between the observed value and simulated value of liquid level meters M1 and M5 were 1.4 cm and 1.1 cm, respectively. Thus, the corrected results of the transfer factor of the inspection wells of the sewage pipe network were more scientific and reasonable in the two examples, both of which can ensure that the simulated value of the model was consistent with the actual observed value at the monitoring point.

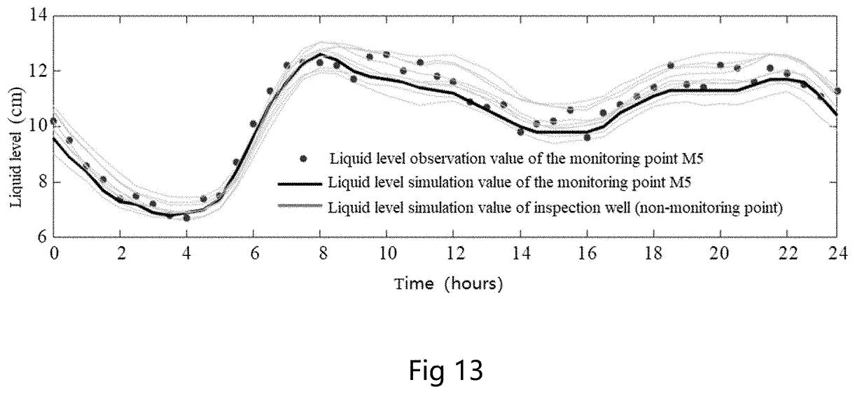

FIG. 13 showed the comparison of the real-time simulated values and the actual observed values of the liquid level meter M5 and the real-time simulated values of water depth of 10 nearby inspection wells in the example sewage pipe network XZN. By monitoring the real-time water depth of M5 at each time point, if the water depth fluctuates beyond the normal range in a certain period of time, an alarm will be given, and then by analyzing the real-time water depth data of all nearby inspection wells, the location of abnormal events (such as illegal discharge, leakage, etc.) can be quickly determined.

Thus, by allocating the water consumption at each time point in the water supply pipe network model of the same area to the nearest inspection well of the sewage pipe network using the real-time simulation method of sewage pipe network driven by water supply IoT data provided in the present invention, and determining the transfer factor between the node water consumption and the inspection well inflow by an optimization method, the real-time simulation of the liquid and flow parameters of the entire sewage pipe network is realized, which provides an important technical support for effectively solving the problems of blockage, leakage, decomposition, illegal discharge, rain water and sewage misconnection and sewage overflow, etc., with good values of promotion and practical engineering applications.

The foregoing embodiment is only a preferred solution of the present invention, but it is not intended to limit the present invention. Those of ordinary skill in the art can make various changes and modifications without departing from the spirit and scope of the present invention. Therefore, all technical solutions obtained by equivalent substitutions or equivalent transformations shall fall within the scope of protection of the present invention.

What is claimed is:

1. A real-time simulation method of sewage pipe network driven by water supply IoT data, comprising the following steps:
process 1: offline module, including three stages S1, S2 and S3, the execution frequency and number of times of offline module are determined according to actual needs,
S1: integrating a hydraulic model of a sewage pipe network and a water supply pipe network according to the steps S11 to S12,
S11: establishing a hydraulic model of a sewage pipe network and a water supply pipe network based on parameter information of model components such as water supply pipes, reservoirs, pumping stations, sewage pipes, inspection wells, etc. provided by a geographic information system GIS,
S12: establishing a mapping relationship between nodes of the water supply network model and the inspection wells of the sewage pipe network model based on the spatial analysis functions of GIS, so that the drainage of each water supply node in the model enters a spatially nearest sewage inspection well;
S2: correcting the historical water consumption of each node in the hydraulic model of the water supply pipe network according to steps S21 to S27,
S21: setting the required related parameters: observed values H^{o} and Q^{o} in all pressure monitoring points and flow monitoring points in the water supply pipe network at a historical time point t; an error threshold; a maximum number S of iterations and an adjustment range p of node water consumption,
S22: initializing the water consumption of each node at a historical time point t: for a water supply pipe network with a given number Nₓ of nodes, intelligent water meters are installed at N_{y} nodes (y<x), firstly the water consumption of N_{y} separate metering is allocated to the corresponding nodes, and the remaining water is distributed to the remaining Nₓ−N_{y} nodes in proportion to the length of the pipe connecting each node with the adjacent nodes according to the following formula:
$${g}_{r}^{initial} = \frac{{l}_{r}}{{L}_{T} - {L}_{M}} ( {Q}_{T} - {Q}_{M} ) \qquad 1 - 1$$
in the formula, qᵣ^{initial} (r=1, 2, . . . , Nₓ−N_{y}) is the node water consumption of the node r allocated in proportion to the length of the pipe at a historical time point t after initialization, lᵣ is the total length of the pipe connected to the node r, L_{T} is the total length of the pipe of the water supply pipe network, L_{M} is the total length of the pipe connected to the intelligent water meter node; Q_{T} is the total water supply volume of the water supply pipe network; Q_{M} is the total water volume of the intelligent water meter at a historical time point t,
there are a total of Nₓ nodes in the pipe network, intelligent water meters are installed in a part of nodes (N_{y}) and the water consumption at a historical time point t is directly available from the intelligent water meters, while no intelligent water meters are installed in another part of nodes (Nₓ−N_{y}) and the water consumption at a historical time point t is unknown, and the water consumption of these nodes (Nₓ−N_{y}) at the historical time point t is calculated according to the formula 1-1, the total initial water consumption of all nodes in the water supply pipe network at the historical time point t is equal to the sum of the initial water consumptions of all nodes (a total of Nₓ nodes) at the historical time point t,
S23: calculating the residual between the observed value and the simulated value at the pressure and flow monitoring points at the historical time point t: running the hydraulic simulation of the water supply pipe network and calculating (s=1, 2, . . . , S) at the s-th iteration, wherein,
the residual between the observed value and the simulated value at the pressure monitoring points is:
ΔH^{s}=H^{o}−H(q)=[H₁^{o}−H₁(q)^{s},H₂^{o}−H₂(q)^{s}, . . . ,H_{NH}^{o}−H_{NH}(q)^{s}]^{T} 1-2
the residual between the observed value and the simulated value at the flow monitoring points is:
ΔQₛ=Qₒ−Q(q)=[Q₁^{o}−Q₁(q)^{s},Q₂^{o}−Q₂(q)^{s}, . . . ,Q_{NQ}^{o}−Q_{NQ}(q)^{s}]^{T} 1-3
in the formula, NH and NQ are the numbers of pressure and flow monitoring points respectively, Hᵤ^{o} and Hᵤ(q)^{s} are the observed value and the simulated value (u=1, 2, . . . , NH) at the s-th iteration at the pressure monitoring point u, Qᵥ^{o} and Qᵥ(q)^{s} are observed value and the simulated value (v=1, 2, . . . , NH) at the s-th iteration at the pressure monitoring point v, T represents the transposition of vector, and q=[q₁^{s}, q₂^{s} . . . q_{Nx}^{s}] is the vector of the node water consumption at the s-th iteration at the historical time point t;
S24: calculating the adjusted value of the node water consumption at the historical time point t according to the following formula:
$$Δ {q}^{s} = {{( {[ \begin{matrix}{J}_{H} \\ {J}_{Q}\end{matrix} ]}^{T} W [ \begin{matrix}{J}_{H} \\ {J}_{Q}\end{matrix} ] )}^{- 1} [ \begin{matrix}{J}_{H} \\ {J}_{Q}\end{matrix} ]}^{T} W [ \begin{matrix}Δ {H}^{s} \\ Δ {Q}^{s}\end{matrix} ] \qquad 1 - 4$$
in the formula, J_{H} and J_{Q} are the Jacobian matrices of the water supply pipe network at the s-th iteration; wherein,
$${J}_{H} = \frac{\partial H ( q )}{\partial q} {\vert}_{q = {q}^{s}} , {J}_{Q} = \frac{\partial Q ( q )}{\partial q} {\vert}_{q = {q}^{s}} ;$$
wₕ^{u}=1/(Hᵤ^{o})² and w_{q}^{v}=1/(Qᵥ^{o})² represent the weight coefficients of pressure monitoring point u and the flow monitoring point v respectively; w=diag([wₕ¹, wₕ², . . . , wₕ^{NH}, w_{q}¹, w_{q}², . . . , q_{q}^{NQ}]) is the vector of weight coefficients,
S25: updating the water consumption of each node according to the following formula:
$$\begin{matrix}{q}^{s + 1} = {q}^{s} + Δ {q}^{s} & 1 - 5 \\ {q}_{r}^{s + 1} = \{ \begin{matrix}{q}_{r}^{min} , & if {q}_{r}^{s + 1} < {q}_{r}^{min} \\ {q}_{r}^{max} , & if {q}_{r}^{s + 1} > {q}_{r}^{max} \\ {q}_{r}^{s + 1} , & others\end{matrix} & 1 - 6\end{matrix}$$
in the formula, q^{s+1} is the water consumption of each node at the s+1-th iteration at the historical time point t; qᵣ^{min}=(1−p)×qᵣ^{initial} and qᵣ^{max}=(1+p)×qᵣ^{initial} are the minimum and maximum water consumption of a node r at the historical time point t respectively, generally p=10%˜20%,
S26: repeating the process S23 to S24 until ∥Δq^{s}∥<ε or s>S, generally ε=0.01, S=100,
S27: repeating the process S21 to S26 to obtain the data of node water consumption of the water supply pipe network whose historical time cycle is T (usually 2 weeks) and time accuracy is Δt (the time difference between two successive time points t, usually half an hour) for calculation in S3;
S3: establishing a sewage pipe network model to correct a single-objective optimization model according to the steps S31 to S32, and determining the transfer factor between the water consumption of each node and the inflow of the inspection well,
S31: establishing a single objective function according to the following formula:
$$Minimization function : F ( K ) = {\sum }_{t = {T}_{w}}^{T} ( {\sum }_{i = 1}^{M} {[ g ( {h}_{i}^{o} ( t ) ) - g ( {h}_{i}^{s} ( t ) ) ]}^{2} + {\sum }_{j = 1}^{N} {[ g ( {f}_{j}^{o} ( t ) ) - g ( {f}_{j}^{s} ( t ) ) ]}^{2} ) \qquad 1 - 7$$
$$[ {h}_{i}^{s} , {f}_{i}^{s} ] = [ {h}_{i}^{s} ( {t}_{1} ) , {h}_{i}^{s} ( {t}_{2} ) , … , {h}_{i}^{s} ( T ) ; {f}_{j}^{s} ( {t}_{1} ) , {f}_{j}^{s} ( {t}_{2} ) , … , {f}_{j}^{s} ( T ) ] = {F}_{s} ( D ( T ) ) \qquad 1 - 8$$
$$D ( T ) = [ \begin{matrix}{d}_{1} ( {t}_{1} ) , {d}_{2} ( {t}_{2} ) , … {d}_{n} ( {t}_{1} ) \\ {d}_{1} ( {t}_{1} ) , {d}_{2} ( {t}_{2} ) , … {d}_{n} ( {t}_{2} ) \\ …………………………… \\ {d}_{1} ( T ) , {d}_{2} ( T ) , … {d}_{n} ( T )\end{matrix} ] \qquad 1 - 9$$
$${d}_{l} ( t ) = {k}_{l} \times {q}_{l} ( t ) \qquad 1 - 10$$
$${k}_{l}^{min} \leq {k}_{l} \leq {k}_{l}^{max} , l = 1 , 2 , … , n \qquad 1 - 11$$
in the formula, K=[k₁, k₂, . . . kₙ]^{T}, kₗ is the water consumption transfer factor of the inspection well l in the sewage pipe network model, T is the total simulation time of the model correction of the sewage pipe network, T_{w} is the simulation hot start time of the sewage pipe network, M and N are the quantities of liquid level meters and flow meters installed in the sewage pipe network respectively, and are obtained in the sewage pipe network data acquisition system; hᵢ^{o}(t) and hᵢ^{s}(t) are the liquid level observation value and simulation value at the liquid level monitoring point i at the historical time point t respectively, fⱼ^{o}(t) and fⱼ^{s}(t) are the flow observation value and simulation value at the flow monitoring point j at the historical time point t respectively, hᵢ^{s}=[hᵢ^{s}(t₁), hᵢ^{s}(t₂), . . . , hᵢ^{s}(T)] [symbol] fᵢ^{s}s=[fⱼ^{s}(t₁), fⱼ^{s}(t₂), . . . , fⱼ^{s}(T)] are the vectors of simulation values of the liquid level monitoring point i and the flow monitoring point j at all time points in the entire historical cycle T, Fₛ(D(T)) is the combination vector of hᵢ^{s} and fᵢ^{s}, D(T) is a T×n matrix, representing the inflow of all inspection wells n at all time points in the entire cycle T, dₗ(t) is the inflow of the inspection well l at the historical time point t, qₗ(t) is the water consumption correction value of the water supply pipe network node corresponding to the inspection well l at the historical time point t; kₗ^{min} and kₗ^{max} are the minimum and maximum values of kₗ respectively; g( ) is a linear conversion function used to convert the liquid level and flow into the same interval, i.e. the range of 0 to 1, which is defined as:
$$g ( x ) = \frac{x - {x}_{min}}{{x}_{max} - {x}_{min}} \qquad 1 - 12$$
in the formula, x represents the observed value or simulated value of the monitoring point; xₘᵢₙ and xₘₐₓ are the upper limit and lower limit, which are generally obtained based on historical data statistics of a period of time (for example, 30 days) at the monitoring point,
S32: solving the single-objective optimization model: using the genetic algorithm in the prior art to solve the optimization model and obtain the water consumption transfer factor kₗ (l=1, . . . , n) of each inspection well i;
process 2: real-time online module, including S4 stage, S4 stage is executed once every time point,
S4: realizing the real-time simulation of hydraulic parameters of the sewage pipe network model according to the steps S41 to S43,
S41: obtaining the pressure, flow and water consumption data at the current time point t from the pressure gauges, flow meters and intelligent water meters of the water supply pipe network, and correcting the node water consumption of the hydraulic model of the water supply pipe network at the current time point t according to the procedure S2,
S42: calculating the inflow dₗ(t) of the current time point of each inspection well in the sewage pipe network according to formula 1-10 based on the water consumption of each node of the water supply system at the current time point t obtained in S41 and the water consumption transfer factor of each inspection well obtained in S3,
S43: running the hydraulic model of the sewage pipe network to simulate the liquid level and the flow hydraulic parameters of the entire sewage pipe network with a time accuracy of Δt (usually half an hour) in real time.
